(19) United States
(12) Patent Application Publication
(10) Pub. No.: US 2025/0165672 A1
(43) Pub. Date: May 22, 2025

(54) Method and Systems for Managing Coiled Tubing String in Full Life Cycle, and Storage Medium

(71) Applicant: YANTAI JEREH PETROLEUM EQUIPMENT & TECHNOLOGY CO., LTD., Yantai (CN)

(72) Inventors: Haiping XING, Yantai (CN); Hao YANG, Yantai (CN); Zhengqi WANG, Yantai (CN); Haiwei WANG, Yantai (CN)

(73) Assignee: YANTAI JEREH PETROLEUM EQUIPMENT & TECHNOLOGY CO., LTD., Yantai (CN)

(21) Appl. No.: 19/032,103

(22) Filed: Jan. 19, 2025

Related U.S. Application Data
(63) Continuation of application No. PCT/CN2022/106478, filed on Jul. 19, 2022.

(51) Int. Cl. G06F 30/20; E21B 17/20; G06F 111/10

(52) U.S. Cl. CPC G06F 30/20; E21B 17/20; G06F 2111/10

(57) ABSTRACT

Provided are a method and systems for operating a coiled tubing string in a full life cycle including N life cycles. The method includes: establishing a data file for the coiled tubing string to configure various parameters of the coiled tubing string including at least one of a material grade and an outer diameter of the coiled tubing string, a length, a wall thickness and a weld type of each tubing section; adding invokable execution items in an n^{th} life cycle and configuring operation data corresponding to the invokable execution items in the n^{th} life cycle; executing the invokable execution items in the n^{th} life cycle to obtain an execution result; evaluating the execution result to generating a report on a current state of the string; and evaluating a service state of the coiled tubing string according to the report. The method facilitates safe operations in oil and gas wells.

### CROSS REFERENCE

This application is based on and claims the benefit of priority to PCT International Patent Application No. PCT/CN2022/106478, filed on Jul. 19, 2022, the entirety of which is herein incorporated by reference.

### TECHNICAL FIELD

Embodiments of the present disclosure relate to a method and systems for managing a coiled tubing string in a full life cycle, and a storage medium.

### BACKGROUND

With the increasing maturity of the coiled tubing operation technology and the unparalleled functions of coiled tubing equipment as a “universal operating machine”, it can achieve operation tasks such as sand flushing and blockage removal, gas lifting, fishing, dragging and acidification, bridge plug drilling and grinding and fracturing for oil and gas wells. Coiled tubing operation services have become an indispensable and important part of oil and gas field operations.

### SUMMARY

At least one embodiment of the present disclosure provides a method for managing a coiled tubing string in a full life cycle, the full life cycle including N life cycles, the method including: establishing a data file for the coiled tubing string to configure various parameters of the coiled tubing string, the various parameters including a material grade and an outer diameter of the coiled tubing string, and a length, a wall thickness and a weld type of each tubing section; adding management items in an n^{th} life cycle and configuring management data corresponding to the management items in the n^{th} life cycle; executing the management items in the n^{th} life cycle to obtain an execution result; checking and evaluating the execution result for the management items in the n^{th} life cycle, and generating a report on a current state of the coiled tubing string according to the execution result; and evaluating a service state of the coiled tubing string according to the report on the current state of the coiled tubing string, where N is an integer greater than 0, and n is an integer greater than 0 and less than N.

For example, in the method for managing the coiled tubing string in the full life cycle provided in at least one embodiment of the present disclosure, the management items in the n^{th} life cycle include maintenance, on-site operation tasks, and defect monitoring of the coiled tubing string.

For example, in the method for managing the coiled tubing string in the full life cycle provided in at least one embodiment of the present disclosure, the management data corresponding to the management items in the n^{th} life cycle include: configuration data for a management item related to a duct between drums, configuration data for a management item related to a cut-off string portion, configuration data for a management item related to a connected string portion, configuration data for a management item related to anti-corrosion, configuration data for a management item related to historical operation tasks, configuration data for a management item related to real-time operation tasks, and configuration data for a management item related to defect detection of the coiled tubing string.

For example, in the method for managing the coiled tubing string in the full life cycle provided in at least one embodiment of the present disclosure, executing the management items in the n^{th} life cycle to obtain an execution result includes: for the management items related to maintenance and on-site operation tasks of the coiled tubing string, executing prediction of fatigue life loss of the coiled tubing string to calculate a percentage of the fatigue life loss corresponding to each length position of the coiled tubing string; and for the defect detection of the coiled tubing string, executing detection of slots, pits and mechanical damage on inner and outer surfaces of the coiled tubing string, and detection of the outer diameter, ellipticity and wall thickness of the coiled tubing string.

For example, in the method for managing the coiled tubing string in the full life cycle provided in at least one embodiment of the present disclosure, the prediction of the fatigue life loss of the coiled tubing string is executed through a bending deformation fatigue life prediction model, a corrosion life prediction model, and a mechanical damage life prediction model.

For example, in the method for managing the coiled tubing string in the full life cycle provided in at least one embodiment of the present disclosure, the bending deformation fatigue life prediction model is:

N_{b}=1/2ε′^{f}(εₐₚ)^{1/c}*kₗ
where N_{b} is a bending deformation fatigue life of the coiled tubing string, k is a confidence coefficient of the bending deformation fatigue life prediction model, c is a material ductility index of the coiled tubing string, εₐₚ is an equivalent bending strain, and ε′_{f} is a material ductility coefficient of the coiled tubing string.

For example, in the method for managing the coiled tubing string in the full life cycle provided in at least one embodiment of the present disclosure, the corrosion life prediction model for the coiled tubing string is:

$${k}_{c} = 0.0015 {ρ}^{2} + 0.0798 ρ + 1.5242$$

$${k}_{s} = 0.6$$

where k_{c} is an acid solution corrosion life derating coefficient, ρ is an acid solution concentration, and kₛ is an H2S corrosion derating coefficient.

For example, in the method for managing the coiled tubing string in the full life cycle provided in at least one embodiment of the present disclosure, the mechanical damage life prediction model for the coiled tubing string is:

$${k}_{d} = {e}^{[ - {a}_{31} + \frac{{a}_{31}}{( 1 + {( \frac{Q}{{a}_{32}} )}^{{a}_{33}} )} ]}$$

$$Q = {[ ( \frac{d}{t} ) ( \frac{w}{l} ) {( \frac{{A}_{p}}{{A}_{c}} )}^{0.5} ]}^{\frac{1}{3}}$$

where k_{d} is a mechanical damage life derating coefficient, d, w and l are respectively a depth, a width and a length of a defect caused by the mechanical damage, t is a wall thickness of the coiled tubing string, Aₚ is a projection area of the defect caused by the mechanical damage on a cross section of the coiled tubing string, and A_{c} is a cross-sectional area of the coiled tubing string, a₃₁=9.222, a₃₂=1.0339, and a₃₃=2.20735.

For example, in the method for managing the coiled tubing string in the full life cycle provided in at least one embodiment of the present disclosure, the report on the current state of the coiled tubing string includes fatigue life loss, times of being putted in and taken out of wells, operating mileage, defects caused by slots, pits and mechanical damage on inner and outer surfaces, and changes in outer diameter and wall thickness.

For example, in the method for managing the coiled tubing string in the full life cycle provided in at least one embodiment of the present disclosure, evaluating a service state of the coiled tubing string according to the report on the current state of the coiled tubing string includes: performing comprehensive evaluation on whether the coiled tubing string needs to be retired or abandoned; if yes, executing abandonment treatment management; or otherwise, adding management items in an (n+1)^{th} life cycle.

For example, in the method for managing the coiled tubing string in the full life cycle provided in at least one embodiment of the present disclosure, the configuration data for a management item related to a duct between drums include: a task type, an execution location, execution time, a person in charge, an original drum size, and a target drum size.

For example, in the method for managing the coiled tubing string in the full life cycle provided in at least one embodiment of the present disclosure, the configuration data for a management item related to a cut-off string portion include: a task type, an execution location, execution time, a person in charge, an original drum size, a target drum size, a cut-off position, and a cut-off length.

For example, in the method for managing the coiled tubing string in the full life cycle provided in at least one embodiment of the present disclosure, the configuration data for a management item related to a connected string portion include: a task type, an execution location, execution time, a person in charge, an original drum size, a target drum size, an outer diameter of the connected string portion, a wall thickness of the connected string portion, a material of the wall thickness of the connected string portion, a connected position, a connected length, and a weld type.

For example, in the method for managing the coiled tubing string in the full life cycle provided in at least one embodiment of the present disclosure, the configuration data for a management item related to anti-corrosion include: a task type, an execution location, execution time, a person in charge, a corrosion inhibitor model, a corrosion inhibitor dosage, a nitrogen gas N₂ dosage, protection of inner/outer surfaces of the string, and effective protection days.

For example, in the method for managing the coiled tubing string in the full life cycle provided in at least one embodiment of the present disclosure, the configuration data for a management item related to historical operation tasks include: an operation name, an operation type, an operation location, operation time, a person in charge, whether to perform an over-acid operation, whether hydrogen sulfide H₂S gas exists in an operation well, and an operation depth and operation pressure imported from historical operation data acquisition software at a current time.

For example, in the method for managing the coiled tubing string in the full life cycle provided in at least one embodiment of the present disclosure, the configuration data for a management item related to real-time operation tasks include: an operation name, an operation type, an operation location, operation time, a person in charge, and an operation depth and operation pressure imported from real-time operation data acquisition software at a current time.

For example, in the method for managing the coiled tubing string in the full life cycle provided in at least one embodiment of the present disclosure, the configuration data for a management item related to defect detection of the coiled tubing string include: a detection location, detection time, a person in charge, and a detection equipment model.

At least one embodiment of the present disclosure further provides a system for managing a coiled tubing string in a full life cycle, the full life cycle including N life cycles, the system including: an establishment unit, configured to establish a data file for the coiled tubing string to configure various parameters of the coiled tubing string, the various parameters including a material grade and an outer diameter of the coiled tubing string, and a length, a wall thickness and a weld type of each tubing section; a configuration unit, configured to add management items in an n^{th} life cycle and configure management data corresponding to the management items in the n^{th} life cycle; an execution unit, configured to execute the management items in the n^{th} life cycle to obtain an execution result; a check unit, configured to check and evaluate the execution result for the management items in the n^{th} life cycle, and generate a report on a current state of the coiled tubing string according to the execution result; and an evaluation unit, configured to evaluate a service state of the coiled tubing string according to the report on the current state of the coiled tubing string, where N is an integer greater than 0, and n is an integer greater than 0 and less than N.

At least one embodiment of the present disclosure further provides a system for managing a coiled tubing string in a full life cycle, including: a processor; a memory; and one or more computer program modules, the one or more computer program modules being stored in the memory and configured to be executed by the processor to implement the method for managing the coiled tubing string in the full life cycle provided in any embodiment of the present disclosure.

At least one embodiment of the present disclosure further provides a storage medium, storing computer-readable instructions non-temporarily, the computer-readable instructions, when executed by a computer, implementing the method for managing the coiled tubing string.

### BRIEF DESCRIPTION OF THE DRAWINGS

In order to more clearly describe the technical solutions of the embodiments of the present disclosure, the accompanying drawings of the embodiments will be briefly described below. Clearly, the accompanying drawings described below only relate to some embodiments of the present disclosure, and are not intended to limit the present disclosure.

FIG. 1 is an example flowchart of a method for managing a coiled tubing string in a full life cycle provided in at least one embodiment of the present disclosure;

FIG. 2 is an example flowchart of another method for managing a coiled tubing string in a full life cycle provided in at least one embodiment of the present disclosure;

FIG. 3 is an example schematic diagram of a coiled tubing string provided in at least one embodiment of the present disclosure;

FIG. 4 is an example schematic composition diagram and execution flowchart of management items related to a coiled tubing string in a life cycle provided in at least one embodiment of the present disclosure;

FIG. 5 is an example schematic data graph of fatigue life loss of a coiled tubing string provided in at least one embodiment of the present disclosure;

FIG. 6 is an example schematic diagram of a system for managing a coiled tubing string in a full life cycle provided in at least one embodiment of the present disclosure;

FIG. 7 is an example schematic diagram of another system for managing a coiled tubing string in a full life cycle provided in at least one embodiment of the present disclosure;

FIG. 8 is an example schematic diagram of an electronic device provided in at least one embodiment of the present disclosure; and

FIG. 9 is an example schematic diagram of a storage medium provided in at least one embodiment of the present disclosure.

### DETAILED DESCRIPTION

To make the purposes, technical solutions and advantages of the embodiments of the present disclosure clearer, the technical solutions in the embodiments of the present disclosure will be described below with reference to the accompanying drawings in the embodiments of the present disclosure. The described embodiments are merely examples of the present disclosure. All other embodiments obtained by those skilled in the art based on the embodiments of the present disclosure without contributing any inventive labor shall still fall within the scope of protection of the present disclosure.

Unless otherwise defined, the technical or scientific terms used in the present disclosure shall have the usual meanings as understood by those skilled in the art to which the present disclosure belongs. Words such as “first,” “second,” and the like used in the present disclosure do not indicate any order, quantity, or importance, but are only intended to distinguish different components. Similarly, words like “one,” “a,” or “the” do not indicate a quantity limit, but indicate the existence of at least one. Words such as “comprising,” “including,” and the like refer to a component or object that appears before the word including those listed after the word and their equivalents, without excluding other components or objects. Words such as “connecting,” “connected,” and the like are not limited to physical or mechanical connection, but may include electrical connection, no matter whether it is direct or indirect connection. “Up,” “down,” “left,” “right,” and the like are only intended to represent relative positional relationships. When the absolute position of a described object changes, the relative positional relationship may also change accordingly.

The main reasons for the failure and abandonment of the coiled tubing string during long-term use on oil and gas field operation sites are as follows: the plastic deformation is caused by repeated bending and straightening on a drum and a gooseneck during the process of being putted in and taken out of the well leads to low cycle fatigue damage, which accumulates to a certain extent and produces fatigue cracks, ultimately resulting in the failure and retirement of the coiled tubing string; in the well, the coiled tubing string may be exposed to acidification treatment operations, saltwater completion fluids, water, and hydrogen sulfide (H2S), which may accelerate corrosion, cause pitting, and reduce the tubing wall thickness; normal operations on the well site may sometimes cause mechanical damage (scratches, abrasions, dents, or slots) to the coiled tubing string due to contact with an injector head, a wellhead, a casing, and completion equipment, as well as contact with abrasive formations in open holes; in the process of being putted in and taken out of the well, inner high pressure causes local swelling of the coiled tubing string; excessive tension applied causes the coiled tubing string to be stretched, thinned and thus necked or crushed; and axial stress may exceed a yield strength of the tubing string, leading to axial yield damage. In order to safely and effectively apply the coiled tubing technology to complete construction operation tasks, it is desired to perform process management on the coiled tubing string in a full life cycle.

At least one embodiment of the present disclosure provides a method for managing a coiled tubing string in a full life cycle. The full life cycle includes N life cycles. The method includes: establishing a data file for the coiled tubing string to configure various parameters of the coiled tubing string, the various parameters including a material grade and an outer diameter of the coiled tubing string, and a length, a wall thickness and a weld type of each tubing section; adding management items in an n^{th} life cycle and configuring management data (alternatively referred to as operation data) corresponding to the management items in the n^{th} life cycle; executing the management items in the n^{th} life cycle to obtain an execution result; checking and evaluating the execution result for the management items in the n^{th} life cycle, and generating a report on a current state of the coiled tubing string according to the execution result; and evaluating a service state of the coiled tubing string according to the report on the current state of the coiled tubing string, where N is an integer greater than 0, and n is an integer greater than 0 and less than N.

At least one embodiment of the present disclosure further provides a system and a storage medium corresponding to the method for managing the coiled tubing string in the full life cycle described above.

The method for managing the coiled tubing string in the full life cycle provided in this embodiment of the present disclosure can achieve the digital, data-driven and effective control of the entire process of the coiled tubing string from the beginning of use, to the execution of management items in each life cycle during use, and finally to the abandonment treatment after the N^{th} management item is executed, integrates methods such as predicting the bending fatigue life of the coiled tubing string, predicting the corrosion life in acidic environments, and predicting the mechanical damage life, and helps to ensure the safety and maximum benefit of the coiled tubing string during on-site operations in oil and gas wells.

The embodiments of the present disclosure and some examples thereof will be described below in detail with reference to the accompanying drawings.

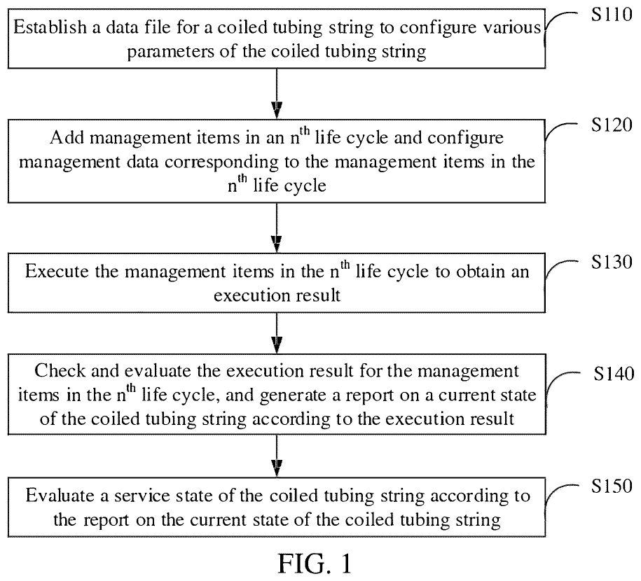

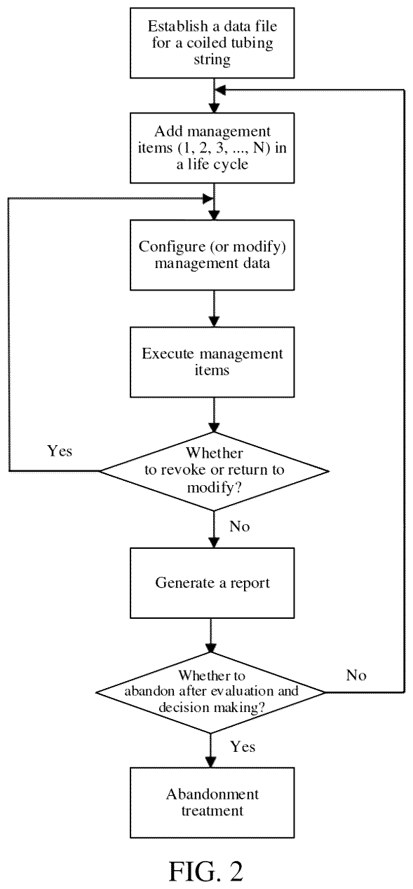

At least one embodiment of the present disclosure provides a method for managing a coiled tubing string in a full life cycle. FIG. 1 is a flowchart of a method for managing a coiled tubing string in a full life cycle provided in at least one embodiment of the present disclosure. FIG. 2 is a flowchart of another method for managing a coiled tubing string in a full life cycle provided in at least one embodiment of the present disclosure. The method for managing the coiled tubing string in the full life cycle provided in at least one embodiment of the present disclosure will be described below in detail with reference to FIG. 1 and FIG. 2. For example, in some examples, referring to FIG. 1, the method for managing the coiled tubing string in the full life cycle includes step S110 to step S150.

In step S110, a data file for the coiled tubing string is established to configure various parameters of the coiled tubing string.

In step S120, management items in an n^{th} life cycle are added, and management data corresponding to the management items in the n^{th} life cycle are configured;

In step S130, the management items in the n^{th} life cycle are executed to obtain an execution result.

In step S140, the execution result for the management items in the n^{th} life cycle is checked and evaluated, and a report on a current state of the coiled tubing string is generated according to the execution result.

In step S150, a service state of the coiled tubing string is evaluated according to the report on the current state of the coiled tubing string.

For example, N is an integer greater than 0, and n is an integer greater than 0 and less than N.

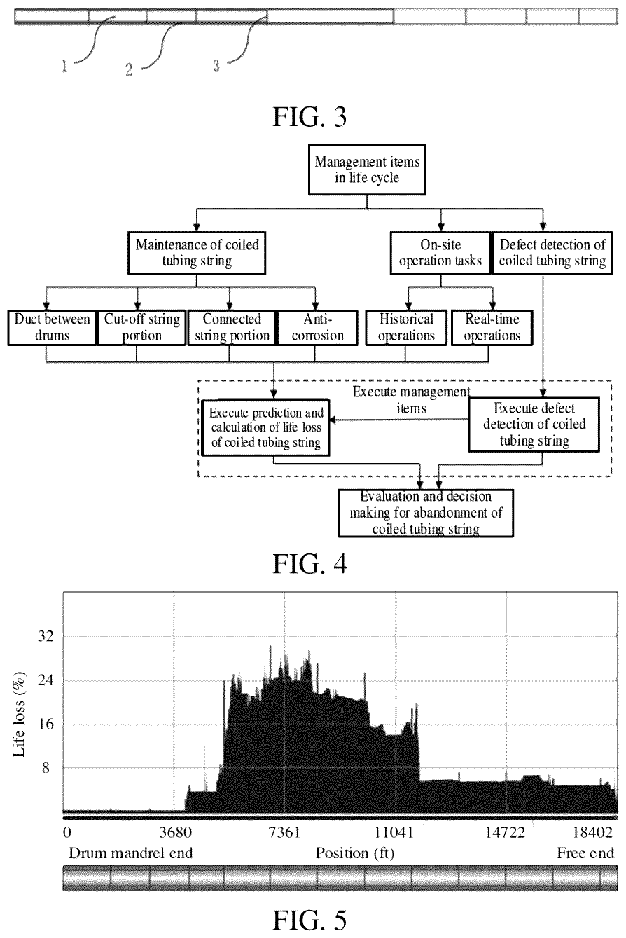

In step S110, for example, in some examples, the various parameters include a material grade and an outer diameter of the coiled tubing string, and a length, a wall thickness and a weld type of each tubing section. Certainly, other parameters may also be included, which are not limited in this embodiment of the present disclosure. For example, the length of each tubing section is as shown in (1) of FIG. 3, the wall thickness is as shown in (2) of FIG. 3, and the weld type is as shown in (3) of FIG. 3, which are not limited in this embodiment of the present disclosure.

In step S120, for example, in some examples, referring to FIG. 4, the management items in the n^{th} life cycle include maintenance, on-site operation tasks, and defect monitoring of the coiled tubing string. For example, the maintenance items (items to be maintained) of the coiled tubing string include a duct between drums, a cut-off string portion, a connected string portion, anti-corrosion, etc. The on-site operation tasks include historical operation tasks, real-time operation tasks, etc. The term management item(s) may be alternatively referred to as invokable execution items.

For example, referring to FIG. 4, the management data corresponding to the management items in the n^{th} life cycle include: configuration data for a management item related to a duct between drums, configuration data for a management item related to a cut-off string portion, configuration data for a management item related to a connected string portion, configuration data for a management item related to anti-corrosion, configuration data for a management item related to historical operation tasks, configuration data for a management item related to real-time operation tasks, configuration data for a management item related to defect detection of the coiled tubing string, and the like, which are not limited in this embodiment of the present disclosure.

For example, the configuration data for a management item related to a duct between drums include a task type, an execution location, execution time, a person in charge, an original drum size, a target drum size, and the like. The configuration data for a management item related to a cut-off string portion include a task type, an execution location, execution time, a person in charge, an original drum size, a target drum size, a cut-off position, a cut-off length, and the like. The configuration data for a management item related to a connected string portion include a task type, an execution location, execution time, a person in charge, an original drum size, a target drum size, an outer diameter of the connected string portion, a wall thickness of the connected string portion, a material of the wall thickness of the connected string portion, a connected position, a connected length, a weld type, and the like. The configuration data for a management item related to anti-corrosion include a task type, an execution location, execution time, a person in charge, a corrosion inhibitor model, a corrosion inhibitor dosage, an N₂ dosage, protection of inner/outer surfaces of the string, effective protection days, and the like. The configuration data for a management item related to historical operation tasks include an operation name, an operation type, an operation location, operation time, a person in charge, whether to perform an over-acid operation, whether H₂S gas exists in an operation well, an operation depth and operation pressure imported from historical operation data acquisition software at a current time, and the like. The configuration data for a management item related to real-time operation tasks include an operation name, an operation type, an operation location, operation time, a person in charge, an operation depth and operation pressure imported from real-time operation data acquisition software at a current time, and the like. The configuration data for a management item related to defect detection of the coiled tubing string include a detection location, detection time, a person in charge, a detection equipment model, and the like. Certainly, more or fewer configuration data may also be included, which are not limited in this embodiment of the present disclosure.

In step S130, executing the management items in the n^{th} life cycle to obtain an execution result includes: for the management items related to maintenance and on-site operation tasks of the coiled tubing string, executing prediction of fatigue life loss of the coiled tubing string to calculate a percentage of the fatigue life loss corresponding to each length position of the coiled tubing string; and for the defect detection of the coiled tubing string, executing detection of slots, pits and mechanical damage on inner and outer surfaces of the coiled tubing string, and detection of the outer diameter, ellipticity and wall thickness of the coiled tubing string.

For example, for the management items related to maintenance and on-site operation tasks of the coiled tubing string, prediction and calculation of the fatigue life loss of the coiled tubing string needs to be executed. The percentage (as shown in FIG. 5) of the fatigue life loss corresponding to each length position of the coiled tubing string may be calculated according to the formula

$${C}_{f} = 100 * \frac{1}{{N}_{f}} ,$$

which serves as a theoretical data basis for evaluating the failure and retirement of the coiled tubing string.

For example, prediction and calculation models for the life of the coiled tubing string include a bending deformation fatigue life prediction model, a corrosion life prediction model, and a mechanical damage life prediction model. That is, the prediction of the fatigue life loss of the coiled tubing string is executed through the bending deformation fatigue life prediction model, the corrosion life prediction model, and the mechanical damage life prediction model.

For example, in some examples, the bending deformation fatigue life prediction model and the mechanical damage life prediction model are configured to execute the management items related to the duct between the drums, the cut-off string portion, the connected string portion, the historical operations, and the real-time operations. The corrosion life prediction model is configured to execute the management items related to the anti-corrosion, the historical operations, and the real-time operations. In the process of executing the management item related to the duct between the drums, the fatigue life of the coiled tubing string is predicted and calculated according to the formula N_{f}=N_{b}k_{d}. In the process of executing the management items related to the historical operations and the real-time operations, the fatigue life of the coiled tubing string is calculated according to the formula N_{f}=N_{b}k_{c}kₛk_{d}.

For example, in some examples, the bending deformation fatigue life prediction model is:

$${N}_{b} = \frac{1}{2 {ε}_{f}^{′}} {( {ε}_{ap} )}^{\frac{1}{c}} * {k}_{l}$$

where N_{b} is a bending deformation fatigue life of the coiled tubing string, kₗ is a confidence coefficient of the bending deformation fatigue life prediction model, c is a material ductility index of the coiled tubing string, εₐₚ is an equivalent bending strain, and ε′_{f} is a material ductility coefficient of the coiled tubing string.

For example, kₗ may be expressed as kₗ=m₄α³+m₃α²+m₂α+m₁, and α is a confidence level of the bending deformation fatigue life prediction model and ranges from 95% to 99.9%.

For example, in some examples,

$${ε}_{ap} = \frac{100 ( D - 2 t )}{2 R + D} .$$

For example, in some examples,

$${ε}_{f}^{′} = \frac{{a}_{14} {{σ}_{e}}^{4} + {a}_{13} {{σ}_{e}}^{3} + {a}_{12} {{σ}_{e}}^{2} + {a}_{11} {{σ}_{e}}^{2} + {a}_{10}}{{a}_{24} {{σ}_{e}}^{4} + {a}_{23} {{σ}_{e}}^{3} + {a}_{22} {{σ}_{e}}^{2} + {a}_{21} {{σ}_{e}}^{2} + {a}_{20}} ,$$

where σₑ is an equivalent bending stress, expressed as:

$${σ}_{e} = \frac{100 {σ}_{h}}{{σ}_{y}} ,$$

where σ_{y} is a yield strength of the material of the coiled tubing string, and σₕ is a circumferential stress, expressed as:

$${σ}_{h} = \frac{P ( \frac{D}{t} - 2 )}{2} ,$$

where P is an internal pressure of the coiled tubing string, D is an outer diameter of the coiled tubing string, and t is a wall thickness of the coiled tubing string.

For example, in some examples, c is expressed as:

$$c = {b}_{5} {{σ}_{e}}^{4} + {b}_{4} {{σ}_{e}}^{3} + {b}_{3} {{σ}_{e}}^{2} + {b}_{2} {σ}_{e} + {b}_{1}$$

It is to be understood that the values of m1 to m4, a10 to a14, a20 to a24, and b1 to b5 in the above model formulas depend on the material properties of different materials of the coiled tubing string, which are not limited in this embodiment of the present disclosure.

For example, in some examples, the corrosion life prediction model for the coiled tubing strings is:

$${k}_{c} = 0.0015 {ρ}^{2} + 0.0798 ρ + 1.5242$$

$${k}_{s} = 0.6$$

where k_{c} is an acid solution corrosion life derating coefficient, ρ is an acid solution concentration, and kₛ is an H2S corrosion derating coefficient.

For example, if no acidic liquid is used or a corrosion inhibitor is used as an anti-corrosion measure during the operation of the coiled tubing string, k_{c}=1. If there is no H2S gas or an H2S inhibitor is used as an anti-corrosion measure during the operation of the coiled tubing string, kₛ=1.

For example, in some examples, the mechanical damage life prediction model for the coiled tubing strings is:

$${k}_{d} = {e}^{[ - {a}_{31} + \frac{{a}_{31}}{( 1 + {( \frac{Q}{{a}_{32}} )}^{{a}_{33}} )} ]}$$

$$Q = {[ ( \frac{d}{t} ) ( \frac{w}{l} ) {( \frac{{A}_{p}}{{A}_{c}} )}^{0.5} ]}^{\frac{1}{3}}$$

where k_{d} is a mechanical damage life derating coefficient, d, w and l are respectively a depth, a width and a length of a defect caused by the mechanical damage, t is a wall thickness of the coiled tubing string, Aₚ is a projection area of the defect caused by the mechanical damage on a cross section of the coiled tubing string, and A_{c} is a cross-sectional area of the coiled tubing string, a₃₁=9.222, a₃₂=1.0339, and a₃₃=2.20735.

The specific calculation process will be described below through specific embodiments.

For example, taking a coiled tubing string made of a CT80 material from manufacturer A as an example, the fatigue life is calculated and predicted. The yield strength of the material of the coiled tubing string is σ_{y}=80000 psi (pound force per square inch), the outer diameter D is 1.75 inches, the wall thickness t is 0.156 inches, the equivalent drum radius R is 60 inches, and the gooseneck radius R is 96 inches. m1=3751.6, m2=−116.55, m3=1.2073, m4=−0.0042, a10=1, a11=0, a12=−0.0012170327, a13=0, a14=0.00000383257, a20=2823.3992, a21=0, a22=0.08427108, a23=0, a24=−0.000058995464, b1=−0.49908439, b2=0.0076789939, b3=−0.00020668278, b4=0.000002793471, and b5=−0.000000019160508. The internal pressure of the coiled tubing string during operation is 5000 psi.

Step 1: The bending deformation fatigue life Nb of the coiled tubing string is calculated. During operation, the internal pressure of the coiled tubing string is 5000 psi It can be calculated that the circumferential stress is

$${σ}_{h} = \frac{P ( \frac{D}{t} - 2 )}{2} = 23045 psi ,$$

the equivalent bending stress is

$${σ}_{e} = \frac{100 {σ}_{h}}{{σ}_{y}} = 28.8 ,$$

the material ductility coefficient of the coiled tubing string is

$${ε}_{f}^{′} = \frac{{a}_{14} {{σ}_{e}}^{4} + {a}_{13} {{σ}_{e}}^{3} + {a}_{12} {{σ}_{e}}^{2} + {a}_{11} {{σ}_{e}}^{2} + {a}_{10}}{{a}_{24} {{σ}_{e}}^{4} + {a}_{23} {{σ}_{e}}^{3} + {a}_{22} {{σ}_{e}}^{2} + {a}_{21} {{σ}_{e}}^{2} + {a}_{20}} = 0.000921 ,$$

and the material ductility index of the coiled tubing string is c=b₅σₑ⁴+b₄σₑ³+b₃σₑ²+b₂σₑ+b₁=−0.3958. The equivalent bending strain for bending deformation on the drum is

$${ε}_{ap} = \frac{100 ( D - 2 t )}{2 R + D} = 1.76 ,$$

and the equivalent bending strain for bending deformation on the gooseneck is

$${ε}_{ap} = \frac{100 ( D - 2 t )}{2 R + D} = 0.74 .$$

The confidence level of the model is α=97%, and the confidence coefficient of the model is kₗ=m₄α³+m₃α²+m₂α+m₁=0.703. It is predicted and calculated that the fatigue life of the coiled tubing string during bending deformation on the drum is

$${N}_{b} = \frac{1}{2 {ε}_{f}^{′}} {( {ε}_{ap} )}^{\frac{1}{c}} * {k}_{l} = \frac{1}{2 * 0.000921} {( 1.76 )}^{\frac{1}{- 0.3958}} \cdot 0.703 = 251 ,$$

and the fatigue life of the coiled tubing string during bending deformation on the gooseneck is

$${N}_{b} = \frac{1}{2 {ε}_{f}^{′}} {( {ε}_{ap} )}^{\frac{1}{c}} * {k}_{l} = \frac{1}{2 * 0.000921} {( 0.74 )}^{\frac{1}{- 0.3958}} \cdot 0.703 = 816.$$

Step 2: The acid solution corrosion life derating coefficient k_{c} of the coiled tubing string is calculated. Calculation is performed by taking the concentration ρ=15% of the acid solution pumped into the coiled tubing string during operation as an example.

$${k}_{c} = 0.0015 {ρ}^{2} + 0.0798 ρ + 1.5242 = 0.6647 .$$

Step 3: The mechanical damage life derating coefficient k_{d} of the coiled tubing string is calculated. Calculation is performed by taking the mechanical damage defect with a depth d=0.03 inches, a width w=0.08 inches, and a length 1=0.4 inches on the outer surface of the coiled tubing string as an example,

$$Q = {[ ( \frac{d}{t} ) ( \frac{w}{l} ) {( \frac{{A}_{p}}{{A}_{c}} )}^{0.5} ]}^{\frac{1}{3}} = 0.2896 , and$$

$${k}_{d} = {e}^{[ - {a}_{31} + \frac{{a}_{31}}{( 1 + {( \frac{Q}{{a}_{32}} )}^{{a}_{33}} )} ]} = 0.59 .$$

Step 4: The percentage C_{f} of the fatigue life loss corresponding to each length position of the coiled tubing string is calculated after management items related to one operation of putting the coiled tubing string in the well and taking it out of the well are executed. During the one operation of putting the coiled tubing string in the well and taking it out of the well, one bending deformation cycle is lost on the drum, and two bending deformation cycles are lost on the gooseneck. Therefore, it can be calculated that

$${C}_{f} = 100 * \frac{1}{{N}_{{f}_{reel}}} + 2 * 100 * \frac{1}{{N}_{f \_ reel}} = \frac{1}{{N}_{b \_ reel} {k}_{c} {k}_{s} {k}_{d}} + 2 * \frac{1}{{N}_{b \_ gsnk} {k}_{c} {k}_{s} {k}_{d}} = 2.73 \% .$$

For example, the defect detection of the coiled tubing string mainly includes detection of defects such as slots, pits and mechanical damage on inner and outer surfaces of the coiled tubing string, and detection of the outer diameter, ellipticity and wall thickness of the coiled tubing string, so as to intuitively know the true physical performance state of the coiled tubing string. Detection result data may be imported into the bending deformation fatigue life prediction model and the mechanical damage life prediction model for the coiled tubing string to execute the management items related to the duct between the drums, the cut-off string portion, the connected string portion, the historical operations, and the real-time operations.

In step S140, for example, the report on the current state of the coiled tubing string includes fatigue life loss, times of being putted in and taken out of wells, operating mileage, defects caused by slots, pits and mechanical damage on inner and outer surfaces, and changes in outer diameter and wall thickness.

For example, the execution result of the management items in this life cycle is checked and evaluated. If it is found that there is any problem with the execution result due to data configuration errors, the execution result may be revoked, the process proceeds to step S120 to modify the management data corresponding to the management items in the life cycle, and then the execution of the management items in step S130 is completed again.

After it is checked and evaluated that the execution result for the management items in this life cycle has no problem, a report on the current state of the coiled tubing string may be generated.

In step S150, for example, evaluating a service state of the coiled tubing string according to the report on the current state of the coiled tubing string includes: performing comprehensive evaluation on whether the coiled tubing string needs to be retired or abandoned; if yes, executing abandonment treatment management; or otherwise, adding management items in an (n+1)^{th} life cycle.

For example, referring to FIG. 2, comprehensive evaluation and decision making are performed on whether the coiled tubing string needs to be retired or abandoned according to the data in the report on the current state of the coiled tubing string. If retirement or abandonment is required, abandonment treatment management is executed. Otherwise, the process may proceed to step S120 to continue adding management items in a subsequent life cycle. The management of the coiled tubing string in the full life cycle is cyclically executed in this way until the N^{th} management item is completely executed, then evaluation and decision making are performed, and finally abandonment treatment is executed.

It is to be understood that in the embodiments of the present disclosure, the process of the method provided in each embodiment of the present disclosure may include more or fewer operations, which may be executed sequentially or in parallel. Although the process of the method described above includes multiple operations appearing in a specific order, it is to be clearly understood that the order of the multiple operations is not limited. The method described above may be executed once or multiple times according to predetermined conditions.

The method for managing the coiled tubing string in the full life cycle provided in this embodiment of the present disclosure can achieve the digital, scientific and effective control of the entire process of the coiled tubing string from the beginning of use, to the execution of management items in each life cycle during use, and finally to the abandonment treatment after the N^{th} management item is executed, integrates methods such as predicting the bending fatigue life of the coiled tubing string, predicting the corrosion life in acidic environments, and predicting the mechanical damage life, and helps to ensure the safety and maximum benefit of the coiled tubing string during on-site operations in oil and gas wells.

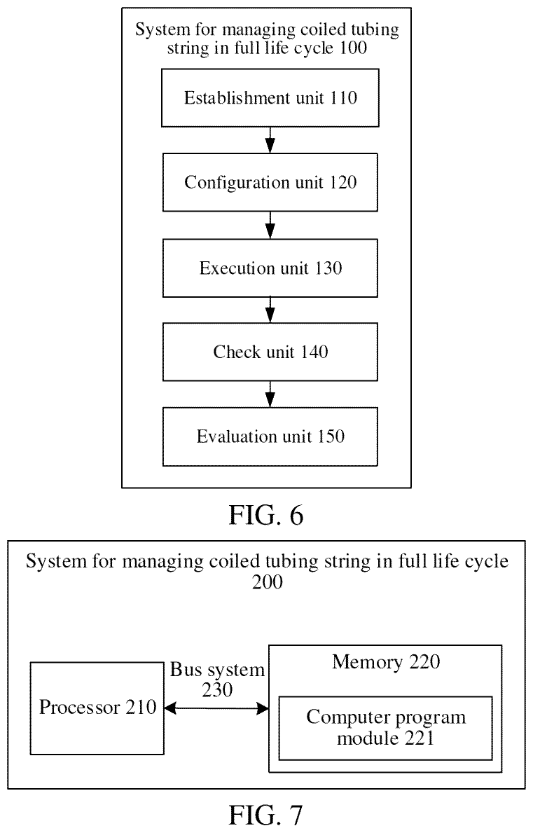

FIG. 6 is a schematic block diagram of a system for managing a coiled tubing string in a full life cycle provided in at least one embodiment of the present disclosure. For example, the full life cycle includes N (N is an integer greater than 0) life cycles. For example, in the example shown in FIG. 6, the system 100 for managing the coiled tubing string in the full life cycle includes an establishment unit 110, a configuration unit 120, an execution unit 130, a check unit 140, and an evaluation unit 150. For example, these units may be implemented through hardware (such as circuit) modules or software modules. The following embodiments are the same, which will not be repeated. For example, these units may be implemented through a Central Processing Unit (CPU), a Graphic Processing Unit (GPU), a Tensor Processing Unit (TPU), a Field Programmable Gate Array (FPGA), or other forms of processing units with data processing capabilities and/or instruction execution capabilities, and corresponding computer instructions.

The establishment unit 110 is configured to establish a data file for the coiled tubing string to configure various parameters of the coiled tubing string. For example, the various parameters include a material grade and an outer diameter of the coiled tubing string, and a length, a wall thickness and a weld type of each tubing section. For example, the establishment unit 110 may implement step S110. For the specific implementation method, a reference may be made to the relevant description of step S110, which will not be repeated here.

The configuration unit 120 is configured to add management items in an n^{th} life cycle and configure management data corresponding to the management items in the n^{th} life cycle. For example, the configuration unit 120 may implement step S120. For the specific implementation method, a reference may be made to the relevant description of step S120, which will not be repeated here.

The execution unit 130 is configured to execute the management items in the n^{th} life cycle to obtain an execution result. For example, the execution unit 130 may implement step S130. For the specific implementation method, a reference may be made to the relevant description of step S130, which will not be repeated here.

The check unit 140 is configured to check and evaluate the execution result for the management items in the n^{th} (n is an integer greater than 0 and less than N) life cycle, and generate a report on a current state of the coiled tubing string according to the execution result. For example, the check unit 140 may implement step S140. For the specific implementation method, a reference may be made to the relevant description of step S140, which will not be repeated here.

The evaluation unit 150 is configured to evaluate a service state of the coiled tubing string according to the report on the current state of the coiled tubing string. For example, the evaluation unit 150 may implement step S150. For the specific implementation method, a reference may be made to the relevant description of step S150, which will not be repeated here.

It is to be understood that in this embodiment of the present disclosure, the system 100 may include more or fewer circuits or units, and the connection relationships between the circuits or units are not limited and may be determined according to actual needs. The specific components of each circuit are not limited. Each circuit may be composed of analog devices or digital chips, or may be composed in other applicable ways.

FIG. 7 is a schematic block diagram of another system for managing a coiled tubing string in a full life cycle provided in at least one embodiment of the present disclosure. For example, referring to FIG. 7, the system 200 for managing the coiled tubing string in the full life cycle includes a processor 210, a memory 220, and one or more computer program modules 221.

For example, the processor 210 and the memory 220 are connected through a bus system 230. For example, the one or more computer program modules 221 are stored in the memory 220. For example, the one or more computer program modules 221 include instructions for executing the method for managing the coiled tubing string in the full life cycle provided in any embodiment of the present disclosure. For example, the instructions in the one or more computer program modules 221 may be executed by the processor 210. For example, the bus system 230 may be a commonly used serial or parallel communication bus, which is not limited in this embodiment of the present disclosure.

For example, the processor 210 may be a Central Processing Unit (CPU), a Digital Signal Processor (DSP), a Graphic Processing Unit (GPU), or other forms of processing units with data processing capabilities and/or instruction execution capabilities, which may be a general-purpose processor or a dedicated processor, and can control other components in the system 200 for managing the coiled tubing string in the full life cycle to execute desired functions.

The memory 220 may include one or more computer program products. The computer program products may include various forms of computer-readable storage media, such as volatile memories and/or non-volatile memories. The volatile memories may include, for example, Random Access Memories (RAMs) and/or cache, etc. The non-volatile memories may include, for example, Read-Only Memories (ROMs), hard disks, flash memories, etc. One or more computer program instructions may be stored on a computer-readable storage medium. The processor 210 may run the program instructions to implement the functions (implemented by the processor 210) and/or other desired functions in this embodiment of the present disclosure, such as the method for managing the coiled tubing string in the full life cycle. The computer-readable storage medium may also store various application programs and various data, such as management data corresponding to management items and various data used and/or generated by application programs.

It is to be understood that for the sake of clarity and simplicity, this embodiment of the present disclosure does not provide all the constituent units of the system 200 for managing the coiled tubing string in the full life cycle. To achieve the necessary functions of the system 200 for managing the coiled tubing string in the full life cycle, those skilled in the art may provide and arrange other components not shown according to actual needs, which are not limited in this embodiment of the present disclosure.

For the technical effects of the system 100 for managing the coiled tubing string in the full life cycle and the system 200 for managing the coiled tubing string in the full life cycle, a reference may be made to the technical effects of the method for managing the coiled tubing string in the full life cycle provided in the embodiment of the present disclosure, which will not be repeated here.

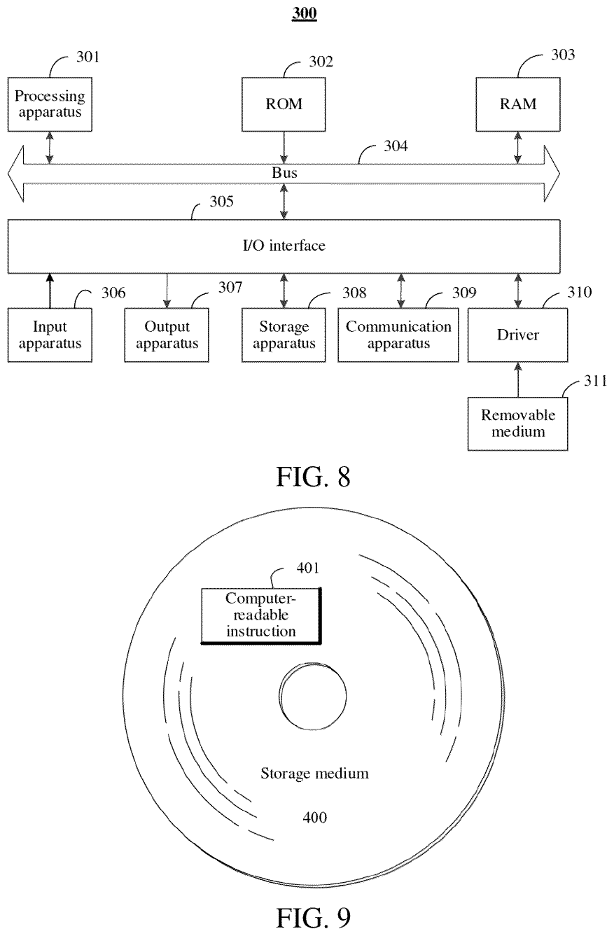

The system 100 for managing the coiled tubing string in the full life cycle and the system 200 for managing the coiled tubing string in the full life cycle may be used for various proper electronic devices. FIG. 8 is a schematic diagram of an electronic device provided in at least one embodiment of the present disclosure. For example, the electronic device is a terminal device, which is not limited in this embodiment of the present disclosure.

For example, referring to FIG. 8, in some examples, an electronic device 300 includes a processing apparatus (such as a central processing unit or graphic processing unit) 301 that may perform various appropriate actions and processes according to programs stored in a Read-Only Memory (ROM) 302 or programs loaded from a storage apparatus 308 into a Random Access Memory (RAM) 303. In the RAM 303, various programs and data required for computer system operations are also stored. The processing apparatus 301, the ROM 302, and the RAM 303 are connected with one another through a bus 304. An input/output (I/O) interface 305 is also connected to the bus 304.

For example, the following components may be connected to the I/O interface 305: an input apparatus 306 including, for example, a touch screen, a touch pad, a keyboard, a mouse, a camera, a microphone, an accelerometer, a gyroscope, or the like; an output apparatus 307 including, for example, a Liquid Crystal Display (LCD), a speaker, a vibrators, or the like, which is configured to display comprehensive evaluation values of components, for example; a storage apparatus 308 including, for example, a magnetic tape, a hard disk, or the like; and a communication apparatus 309 with a network interface card including, for example, an LAN card, a modem, or the like. The communication apparatus 309 may allow the electronic device 300 to communicate with other devices in a wireless or wired manner to exchange data and perform communication processing via a network such as the Internet. A driver 310 is also connected to the I/O interface 305 as required. A removable medium 311, such as a magnetic disk, an optical disk, a magneto-optical disk, a semiconductor memory or the like, is installed on the driver 310 as required, so that computer programs read therefrom can be installed into the storage apparatus 309 as required. Although FIG. 8 shows the electronic device 300 including various apparatuses, it is to be understood that not all of the shown apparatuses are required to be implemented or included. More or fewer apparatuses may be implemented or included alternatively.

For example, the electronic device 300 may further include a peripheral interface (not shown), or the like. The peripheral interface may be an interface of any type, such as a USB interface or a lightning interface. The communication apparatus 309 may communicate with a network and other devices through wireless communication. The network may be, for example, the Internet, an internal network, and/or a wireless network such as a cellular telephone network, a Wireless Local Area Network (LAN), and/or a Metropolitan Area Network (MAN). Wireless communication may adopt any of various communication standards, protocols, and technologies, including but not limited to Global System for Mobile Communications (GSM), Enhanced Data GSM Environment (EDGE), Wideband Code Division Multiple Access (W-CDMA), Code Division Multiple Access (CDMA), Time Division Multiple Access (TDMA), Bluetooth, Wi-Fi (e.g., based on IEEE 802.11a, IEEE 802. 11b, IEEE 802.11g and/or IEEE 802. 11n standards), Voice over Internet Protocol (VoIP), Wi-MAX, protocols used for email, instant messaging, and/or Short Message Service (SMS), or any other suitable communication protocol.

For example, the electronic device may be any device such as a mobile phone, a tablet, a laptop, an e-book, a game console, a television, a digital photo frame, a navigation system or the like, and may also be any combination of electronic devices and hardware, which is not limited in this embodiment of the present disclosure.

For example, according to this embodiment of the present disclosure, the process described with reference to the flowchart above may be implemented as a computer software program. For example, an embodiment of the present disclosure includes a computer program product including a computer program carried on a non-transient computer-readable medium. The computer program includes program code for executing the method shown in the flowchart. In such an embodiment, the computer program may be downloaded and installed from a network through the communication apparatus 309, or installed from the storage apparatus 308, or installed from the ROM 302. When the computer program is executed by the processing apparatus 301, the function of the method for managing the coiled tubing string in the full life cycle defined in the method of the embodiment of the present disclosure is executed.

It is to be understood that the computer-readable medium described in the present disclosure may be a computer-readable signal medium, a computer-readable storage medium, or any combination thereof. The computer-readable storage medium may be, for example, but is not limited to, an electric, magnetic, optical, electromagnetic, infrared, or semiconductor system, apparatus, or device, or any combination thereof. A more specific example of the computer-readable storage medium may include, but not limited to: an electrical connection having one or more conducting wires, a portable computer disk, a hard disk, a Random Access Memory (RAM), a Read-Only Memory (ROM), an Erasable Programmable Read-Only Memory (EPROM or flash memory), an optical fiber, a portable Compact Disk Read-Only Memory (CD-ROM), an optical storage device, a magnetic storage device, or any suitable combination thereof. In this embodiment of the present disclosure, the computer-readable storage medium may be any tangible medium containing or storing a program, and the program may be used by or used in combination with an instruction execution system, apparatus or device. In this embodiment of the present disclosure, the computer-readable signal medium may include a data signal transmitted in a baseband or as a part of a carrier, which carries computer-readable program code. A data signal propagated in such a way may assume a plurality of forms, including, but not limited to, an electromagnetic signal, an optical signal, or any appropriate combination thereof. The computer-readable signal medium may also be any computer-readable medium other than the computer-readable storage medium. The computer-readable signal medium can send, propagate, or transmit a program for use by or in combination with an instruction execution system, apparatus or device. The program code included in the computer-readable medium may be transmitted by using any suitable medium, including but not limited to, a wire, a cable, Radio Frequency (RF) or the like, or any other suitable combination of the above.

In some implementations, a client and a server may communicate with each other by using any currently known or future developed network protocol such as HTTP (Hyper Text Transfer Protocol), and may be in communication connection with digital data in any form or medium (e.g., a communication network). Examples of the communication network include Local Area Networks (LANs), Wide Area Networks (WANs), internet work (for example, the Internet), peer-to-peer networks (for example, ad hoc peer-to-peer networks), and any currently known or future developed networks.

The computer-readable medium above may be included in the electronic device above, or may exist independently without being assembled into the electronic device.

The computer-readable medium above carries one or more programs, which, when executed by the electronic device, cause the electronic device to: acquire at least two Internet Protocol addresses; transmit a node evaluation request containing the at least two Internet Protocol addresses to a node evaluation device, the node evaluation device selecting an Internet Protocol address from the at least two Internet Protocol addresses and returning the Internet Protocol address; and receive the Internet Protocol address returned by the node evaluation device, the acquired Internet Protocol address indicating an edge node in a content delivery network.

Alternatively, the computer-readable medium above carries one or more programs, which, when executed by the electronic device, cause the electronic device to: receive a node evaluation request containing at least two Internet Protocol addresses; select an Internet Protocol address from the at least two Internet Protocol addresses; and return the selected Internet Protocol address, the received Internet Protocol address indicating an edge node in a content delivery network.

The computer program code used for executing the operations of the present disclosure may be written in one or more programming languages or a combination thereof. The programming languages include, but are not limited to, object-oriented programming languages such as Java, Smalltalk and C++, and also include conventional procedural programming languages such as “C” or similar programming languages. The program code may be completely executed on a user computer, partially executed on a user computer, executed as an independent software package, partially executed on a user computer and partially executed on a remote computer, or completely executed on a remote computer or server. For the case involving a remote computer, the remote computer may be connected to a computer of a user through any type of network including a Local Area Network (LAN) or a Wide Area Network (WAN), or may be connected to an external computer (for example, through the Internet by means of an Internet service provider).

The functions described above herein may be at least partially executed by one or more hardware logic components. For example, non-limiting exemplary types of hardware logic components that can be used include: Field Programmable Gate Arrays (FPGAs), Application Specific Integrated Circuits (ASICs), Application Specific Standard Products (ASSPs), System On Chip (SOC), Complex Programmable Logic Devices (CPLDs), etc.

In each embodiment of the present disclosure, the machine-readable medium may be a tangible medium that contains or stores a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium include electrical connections based on one or more wires, portable computer disks, hard drives, Random Access Memories (RAMs), Read-Only Memories (ROMs), Erasable Programmable Read-Only Memories (EPROMs or flash memories), optical fibers, Compact Disk Read-Only Memories (CD-ROMs), optical storage devices, magnetic storage devices, or any suitable combination thereof.

At least one embodiment of the present disclosure further provides a storage medium. FIG. 9 is a schematic diagram of a storage medium provided in at least one embodiment of the present disclosure. For example, referring to FIG. 9, the storage medium 400 stores computer-readable instructions 401 non-temporarily. The non-temporary computer-readable instructions, when executed by a computer (including a processor), implement the method for managing the coiled tubing string in the full life cycle provided in any embodiment of the present disclosure.

For example, the storage medium may be any combination of one or more computer-readable storage media. For example, a computer-readable storage medium contains computer-readable program code for establishing a data file for a coiled tubing string to configure various parameters of the coiled tubing string, another computer-readable storage medium contains computer-readable program code for respectively acquiring evaluation values of the health state of a component to be detected in each dimension based on the operating parameters of each dimension, and another computer-readable storage medium contains computer-readable program code for adding management items in an n^{th} life cycle and configuring management data corresponding to the management items in the n^{th} life cycle. It may also include program code for other steps, which are not limited in this embodiment of the present disclosure. For example, when the program code is read by a computer, the computer can execute the program code stored in the computer storage medium to implement the method for managing the coiled tubing string in the full life cycle provided in any embodiment of the present disclosure.

For example, the storage medium may include a memory card for a smart phone, a storage component for a tablet, a hard disk for a personal computer, a Random Access Memory (RAM), a Read-Only Memory (ROM), an Erasable Programmable Read-Only Memory (EPROM), a portable Compact Disk Read-Only Memory (CD-ROM), a flash memory, or any combination thereof, or may be any other suitable storage medium.

The following several points need to be stated:

(1) The accompanying drawings in the embodiments of the present disclosure only relate to the structures involved in the embodiments of the present disclosure. For other structures, a reference may be made to conventional designs.
(2) Without causing any conflict, the embodiments of the present disclosure and the features in the embodiments may be combined with each other to obtain new embodiments.

Those described above are just exemplary embodiments of the present disclosure and are not intended to limit the scope of protection of the present disclosure. The scope of protection of the present disclosure shall be determined by the appended claims.

What is claimed is:

1. A method for operating a coiled tubing string in a full life cycle, the full life cycle comprising N life cycles, the method comprising:
establishing a data file for the coiled tubing string to configure various parameters of the coiled tubing string, the various parameters comprising at least one of a material grade and an outer diameter of the coiled tubing string, and a length, a wall thickness and a weld type of each tubing section of a plurality of tubing sections of the coiled tubing string;
adding invokable execution items in an n^{th} life cycle and configuring operation data corresponding to the invokable execution items in the n^{th} life cycle;
executing the invokable execution items in the n^{th} life cycle to obtain an execution result;
evaluating the execution result for the invokable execution items in the n^{th} life cycle, and generating a report on a current state of the coiled tubing string according to the execution result; and
evaluating a service state of the coiled tubing string according to the report on the current state of the coiled tubing string,
wherein N is an integer greater than 0, and n is an integer greater than 0 and less than N.

2. The method according to claim 1, wherein the invokable execution items in the n^{th} life cycle comprise maintenance tasks, on-site operation tasks, and defect detection of the coiled tubing string.

3. The method according to claim 2, wherein the operation data corresponding to the invokable execution items in the n^{th} life cycle comprise configuration data for the invokable execution items related to a duct between drums, to a cut-off string portion, to a connected string portion, to anti-corrosion, to historical operation tasks, to real-time operation tasks, and to the defect detection of the coiled tubing string.

4. The method according to claim 2, wherein executing the invokable execution items in the n^{th} life cycle to obtain an execution result comprises:
for the invokable execution items related to the maintenance tasks and on-site operation tasks of the coiled tubing string, predicting a fatigue life loss of the coiled tubing string to calculate a percentage of the fatigue life loss corresponding to each length position of the coiled tubing string; and
for the defect detection of the coiled tubing string, detecting slots, pits and mechanical damage on inner and outer surfaces of the coiled tubing string, and detecting the outer diameter, ellipticity and wall thickness of the coiled tubing string.

5. The method according to claim 4, wherein predicting the fatigue life loss of the coiled tubing string is executed through at least one of a bending deformation fatigue life prediction model, a corrosion life prediction model, and a mechanical damage life prediction model.

6. The method according to claim 5, wherein the bending deformation fatigue life prediction model is represented by:
$${N}_{b} = \frac{1}{2 {ε}_{f}^{′}} {( {ε}_{ap} )}^{\frac{1}{c}} * {k}_{l}$$
wherein N_{b} is a bending deformation fatigue life of the coiled tubing string, k is a confidence coefficient of the bending deformation fatigue life prediction model, c is a material ductility index of the coiled tubing string, εₐₚ, is an equivalent bending strain, and ε′_{f} is a material ductility coefficient of the coiled tubing string.

7. The method according to claim 5, wherein the corrosion life prediction model for the coiled tubing string is represented by:
$${k}_{c} = 0.0015 {ρ}^{2} + 0.0798 ρ + 1.5242$$
$${k}_{s} = 0.6$$
wherein k_{c} is an acid solution corrosion life derating coefficient, ρ is an acid solution concentration, and kₛ is an H2S corrosion derating coefficient.

8. The method according to claim 5, wherein the mechanical damage life prediction model for the coiled tubing string is represented by:
$${k}_{d} = {e}^{[ - {a}_{31} + \frac{{a}_{31}}{( 1 + {( \frac{Q}{{a}_{32}} )}^{{a}_{33}} )} ]}$$
$$Q = {[ ( \frac{d}{t} ) ( \frac{w}{l} ) {( \frac{{A}_{p}}{{A}_{c}} )}^{0.5} ]}^{\frac{1}{3}}$$
wherein k_{d} is a mechanical damage life derating coefficient, d, w and l are respectively a depth, a width and a length of a defect caused by the mechanical damage, t is a wall thickness of the coiled tubing string, Aₚ is a projection area of the defect caused by the mechanical damage on a cross section of the coiled tubing string, and A_{c} is a cross-sectional area of the coiled tubing string, a₃₁=9.222, a₃₂=1.0339, and a₃₃=2.20735.

9. The method according to claim 1, wherein the report on the current state of the coiled tubing string comprises at least one of fatigue life loss, times of being putted in and taken out of wells, operating mileage, defects caused by slots, pits and mechanical damage on inner and outer surfaces, and changes in outer diameter and wall thickness.

10. The method according to claim 1, wherein evaluating the service state of the coiled tubing string according to the report on the current state of the coiled tubing string comprises:
performing evaluation on whether the coiled tubing string needs to be retired or abandoned;
when the coiled tubing string needs to be retired or abandoned, executing abandonment treatment management; or otherwise, adding the invokable execution items in an (n+1)^{th} life cycle.

11. The method according to claim 3, wherein the configuration data for a invokable execution item of the invokable execution items related to a duct between drums comprise: a task type, an execution location, execution time, a person in charge, an original drum size, and a target drum size.

12. The method according to claim 3, wherein the configuration data for a invokable execution item of the invokable execution items related to a cut-off string portion comprise: a task type, an execution location, execution time, a person in charge, an original drum size, a target drum size, a cut-off position, and a cut-off length.

13. The method according to claim 3, wherein the configuration data for a invokable execution item of the invokable execution items related to a connected string portion comprise: a task type, an execution location, execution time, a person in charge, an original drum size, a target drum size, an outer diameter of the connected string portion, a wall thickness of the connected string portion, a material of the wall thickness of the connected string portion, a connected position, a connected length, and a weld type.

14. The method according to claim 3, wherein the configuration data for a invokable execution item of the invokable execution items related to anti-corrosion comprise: a task type, an execution location, execution time, a person in charge, a corrosion inhibitor model, a corrosion inhibitor dosage, a nitrogen gas dosage, protection of inner/outer surfaces of the coiled tubing string, and effective protection days.

15. The method according to claim 3, wherein the configuration data for a invokable execution item of the invokable execution items related to historical operation tasks comprise: an operation name, an operation type, an operation location, operation time, a person in charge, whether to perform an over-acid operation, whether hydrogen sulfide H₂S gas exists in an operation well, and an operation depth and operation pressure imported from historical operation data acquisition software at a current time.

16. The method according to claim 3, wherein the configuration data for a invokable execution item of the invokable execution items related to real-time operation tasks comprise: an operation name, an operation type, an operation location, operation time, a person in charge, and an operation depth and operation pressure imported from real-time operation data acquisition software at a current time.

17. The method according to claim 3, wherein the configuration data for a invokable execution item of the invokable execution items related to defect detection of the coiled tubing string comprise: a detection location, detection time, a person in charge, and a detection equipment model.

18. A system for operating a coiled tubing string in a full life cycle, the full life cycle comprising N life cycles, the system comprising:
an establishment unit, configured to establish a data file for the coiled tubing string to configure various parameters of the coiled tubing string, the various parameters comprising at least one of a material grade and an outer diameter of the coiled tubing string, and a length, a wall thickness and a weld type of each tubing section of a plurality of tubing sections of the coiled tubing string;
a configuration unit, configured to add invokable execution items in an n^{th} life cycle and configure operation data corresponding to the invokable execution items in the n^{th} life cycle;
an execution unit, configured to execute the invokable execution items in the n^{th} life cycle to obtain an execution result;
a check unit, configured to evaluate the execution result for the invokable execution items in the n^{th} life cycle, and generate a report on a current state of the coiled tubing string according to the execution result; and
an evaluation unit, configured to evaluate a service state of the coiled tubing string according to the report on the current state of the coiled tubing string,
wherein N is an integer greater than 0, and n is an integer greater than 0 and less than N.

19. A system for operating a coiled tubing string in a full life cycle, comprising:
at least one processor;
a memory for storing a computer program; and
wherein the at least one processor is configured to execute the computer program to implement the method for managing the coiled tubing string in the full life cycle according to claim 1.

20. A non-transitory storage medium, storing computer-readable instructions, the computer-readable instructions, when executed by a computer, are configured to cause the computer to implement the method for managing the coiled tubing string in the full life cycle according to claim 1.
